(19) United States
(12) Patent Application Publication
(10) Pub. No.: US 2026/0070432 A1
(43) Pub. Date: Mar. 12, 2026

(54) FREIGHT TRANSPORTATION SYSTEM

(71) Applicant: Balasubramanian PURUSHOTHAMAN, Livermore, CA (US)

(72) Inventor: Balasubramanian PURUSHOTHAMAN, Livermore, CA (US)

(21) Appl. No.: 18/827,430

(22) Filed: Sep. 6, 2024

(51) Int. Cl. B60L 50/60; B60L 53/00

(52) U.S. Cl. CPC B60L 50/66; B60L 53/00; B60L 2200/28; B60L 2200/36

(57) ABSTRACT

A freight transportation system includes a container, a semi-trailer, a semi-trailer hauling tractor, a plurality of connecting cables, a power management module, a memory, and a processor. The semi-trailer is configured to transport the container. The container includes a plurality of partitions to house a plurality of batteries to power one or more electric motors placed on the semi-trailer. The semi-trailer hauling tractor is mated with the semi-trailer using one or more linking mechanisms. The electric motors receive power from the batteries and propel the semi-trailer hauling tractor. The connecting cables facilitate two-way data and power transmission among the container, the semi-trailer, and the semi-trailer hauling tractor. The power management module monitors the energy status of the batteries and data, and power transmission with the semi-trailer hauling tractor. The memory stores data related to energy status of the batteries, the destination of freight, and container data.

### TECHNICAL FIELD

The specification is generally directed toward a transportation system and method. More particularly, but not limited to, a freight transportation system and method for operating the freight transportation system.

### DESCRIPTION OF THE RELATED ART

The transportation of freight inherently demands a considerable amount of energy, a majority of which relies on carbon-based sources, contributing to the emission of environmentally harmful carbon dioxide gas. The existing freight transportation systems exhibit several shortcomings. Notably, these systems lack the incorporation of an efficient power storage solution within the transported containers, a feature crucial for supplying the energy required for the self-propulsion of the containers.

In stark contrast to the prevailing methodologies, the present invention seeks to address these deficiencies by introducing a paradigm shift in the energy dynamics of freight transportation. Unlike conventional systems that rely on external power sources, the novel approach envisions integrating power storage directly into the container. This specification recognizes that there is a need for a container that can not only transport the goods but also generate the power necessary for its propulsion.

Moreover, existing systems fall short in embracing zero-carbon energy sources, lacking electrification, and lacking an integrated and comprehensive solution. The proposed freight transportation system aims to revolutionize this landscape by providing an environmentally conscious, electrified, and integrated approach, marking a significant leap towards a sustainable and energy-efficient future for the freight transport industry.

Thus, in view of the above, there is a long-felt need in the transportation industry to address the aforementioned deficiencies and inadequacies.

Further limitations and disadvantages of conventional approaches will become apparent to one of skill in the art through the comparison of described systems with some aspects of the present disclosure, as set forth in the remainder of the present application and with reference to the drawings.

### SUMMARY

An aspect of the present invention relates to a freight transportation system that includes a container, a semi-trailer, a semi-trailer hauling tractor, a plurality of connecting cables, a power management module, a memory, and a processor. The semi-trailer is configured to transport the container. The container includes a plurality of partitions to house a plurality of batteries to power one or more electric motors placed on the semi-trailer. The semi-trailer hauling tractor is mated with the semi-trailer using one or more linking mechanisms. The electric motors receive power from the batteries and propel the semi-trailer hauling tractor. The connecting cables facilitate two-way data and power transmission among the container, the semi-trailer, and the semi-trailer hauling tractor. The power management module monitors the energy status of the batteries and data, and power transmission with the semi-trailer hauling tractor. The memory is connected to the power management module to store data related to the energy status of the batteries, destination of freight, and container data. The processor is in connection with the memory to execute the data stored in the memory.

In an aspect, the container comprises a data transmission module connected to the processor to transmit the data to a remote server.

In an aspect, the remote server is configured to execute a centralized container management software based on the data received from the data transmission module to predict, manage, and plan routes for the freight using a communication system such as GPS, cellular communication, and satellite communication.

In an aspect, the batteries are charged at one or more of a freight handling station, a freight delivery location, and an electric vehicle charging station.

In an aspect, the processor is configured to manage power delivery, braking, and signaling information to the semi-trailer.

In an aspect, the container is disengaged from the semi-trailer during storage, charging, and loading.

In an aspect, the semi-trailer hauling tractor comprises an onboard module or controller configured to manage a propulsion management unit to haul the freight transportation system. Examples of the propulsion management unit include but are not limited to acceleration and brakes.

In an aspect, the batteries are placed in the form of a plurality of slidable and removable racks that fit into the floor of the container.

Another aspect of the present disclosure relates to a method for operating a freight transportation system. The method includes a step of transporting a container using a semi-trailer. In an additional method embodiment, the container includes a plurality of partitions housing a plurality of batteries. The method includes a step of connecting a semi-trailer hauling tractor to the semi-trailer using one or more linking mechanisms. The method includes a step of powering one or more electric motors on the semi-trailer with the batteries housed in the container. The method includes a step of facilitating two-way data and power transmission among the container, the semi-trailer, and the semi-trailer hauling tractor through a plurality of connecting cables. The method includes a step of monitoring the energy status of the batteries and data and power transmission with the semi-trailer hauling tractor using a power management module. The method includes a step of storing data related to the energy status of the batteries, destination of a freight, and container data in a memory connected to the power management module. The method includes a step of executing the stored data in the memory using a processor connected to the memory. The method includes a step of transmitting, by a data transmission module, the data to a remote server.

In an additional method embodiment, the remote server is configured to execute a centralized container management software based on the data received from the data transmission module to predict, manage, and plan routes for the freight using a communication system.

In additional method embodiment, the batteries are charged at either a freight handling station, a freight delivery location, or an electric vehicle charging station.

In an additional method embodiment, the container is disengaged from the semi-trailer during storage, charging, and loading.

In an additional method embodiment, the semi-trailer hauling tractor includes an onboard module configured to manage a propulsion management unit to haul the freight transportation system.

In an additional method embodiment, the batteries are placed in the form of a plurality of slidable and removable racks that fit into the floor of the container.

Thus, the container serves the purpose of supplying electric power to the interconnected trailer system to which it is joined. Specifically, this trailer system comprises both the semi-trailer and the semi-trailer hauling tractor. To enhance flexibility and efficiency, the batteries or battery modules housed within the container can be readily swapped out. This strategic swapping mechanism allows for the optimization of power resources, ensuring that the trailer system meets the energy demands necessary for transporting goods to a predetermined destination.

Other embodiments and advantages will become readily apparent to those skilled in the art upon viewing the drawings and reading the detailed description hereafter, all without departing from the spirit and the scope of the disclosure. The drawings and detailed descriptions presented are to be regarded as illustrative in nature and not in any way as restrictive.

### BRIEF DESCRIPTION OF THE DRAWINGS

The accompanying drawings illustrate the embodiments of systems, methods, and other aspects of the disclosure. Any person of ordinary skill in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale. Reference numerals may be selectively repeated across images for clarity or emphasis.

Various embodiments will hereinafter be described in accordance with the appended drawings, which are provided to illustrate, not limit, the scope, wherein similar designations denote similar elements, and in which:

FIG. 1 illustrates a block diagram showing an example architecture of a freight transportation system, in accordance with one or more example embodiments.

FIG. 2 illustrates a perspective view of integrating the container, semi-trailer, and the semi-trailer hauling tractor, in accordance with one or more example embodiments.

FIG. 3 illustrates a perspective view of the container, in accordance with one or more example embodiments.

FIG. 4 is a flowchart of a method for operating the freight transportation system, in accordance with one embodiment of the present disclosure.

### DETAILED DESCRIPTION

The present description is best understood with reference to the detailed figures and description set forth herein. Various embodiments of the present system and method have been discussed with reference to the figures. However, those skilled in the art will readily appreciate that the detailed description provided herein with respect to the figures is merely for explanatory purposes, as the present system and method may extend beyond the described embodiments. For instance, the teachings presented and the needs of a particular application may yield multiple alternative and suitable approaches to implement the functionality of any detail of the present systems and methods described herein. Therefore, any approach to implement the present system and method may extend beyond certain implementation choices in the following embodiments.

According to an embodiment herein, the methods of the present invention may be implemented by performing or completing manually, automatically, and/or a combination of thereof. The term “method” refers to manners, means, techniques, and procedures for accomplishing any task including, but not limited to, those manners, means, techniques, and procedures either known to the person skilled in the art or readily developed from existing manners, means, techniques and procedures by practitioners of the art to which the present invention belongs. The persons skilled in the art will envision many other possible variations within the scope of the present system and method described herein.

The present disclosure provides a freight transportation system consisting of a container in conjunction with a semi-trailer fitted with a semi-trailer hauling tractor.

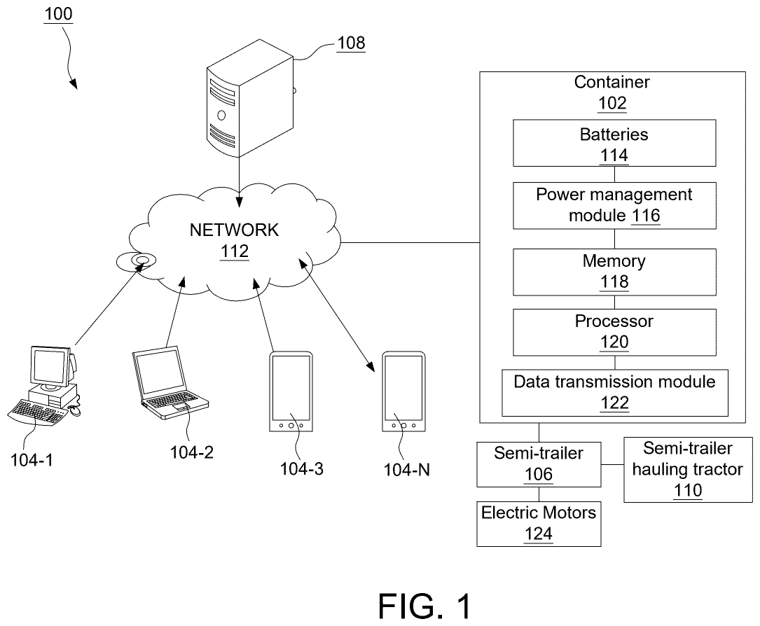

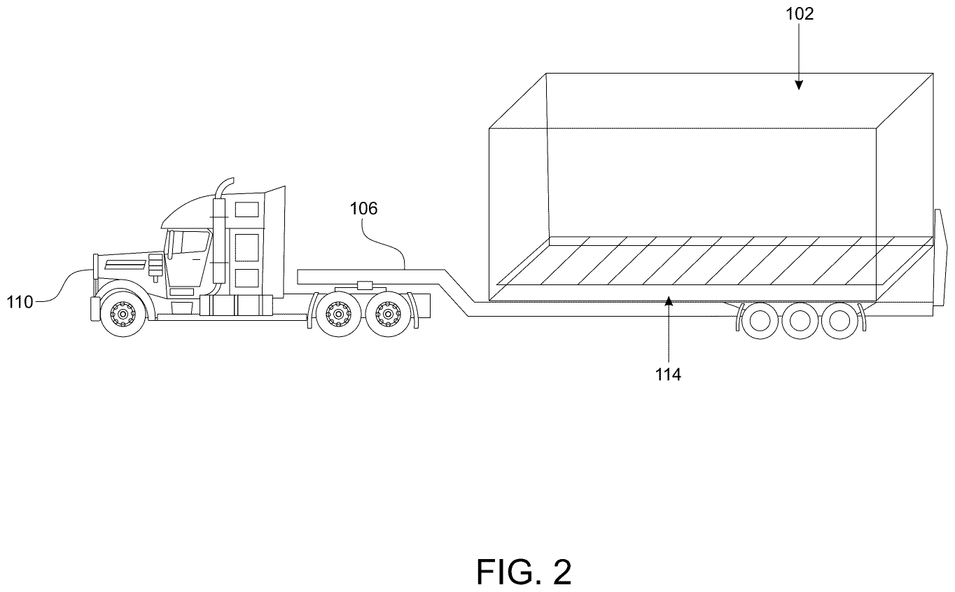

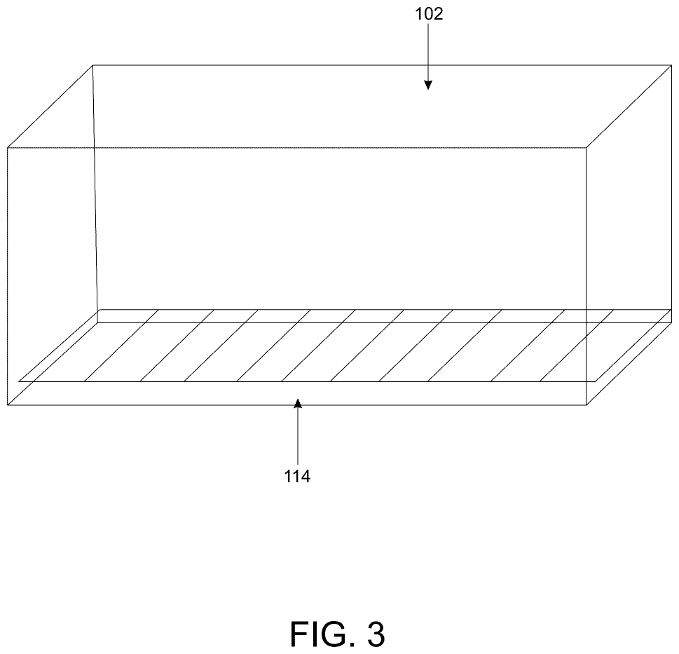

FIG. 1 illustrates a block diagram showing an example architecture of a freight transportation system 100, in accordance with one or more example embodiments. The freight transportation system 100 includes a container 102, a semi-trailer 106, a semi-trailer hauling tractor 110, and a plurality of connecting cables (not shown). The container 102 includes a plurality of batteries 114, a power management module 116, a memory 118, a processor 120, and a data transmission module 122. The semi-trailer 106 is configured to transport the container 102. The container 102 includes a plurality of partitions (shown in FIGS. 2-3) to house a plurality of batteries 114 to power one or more electric motors 124 placed on the semi-trailer 106. The semi-trailer hauling tractor 110 is mated with the semi-trailer 106 using one or more linking mechanisms. The mating or connection of the semi-trailer hauling tractor 110 with the semi-trailer 106 involves several mechanisms designed to ensure a secure and functional attachment such as gooseneck coupling, pintle hook and lunette ring, automatic locking systems, air and electrical lines. The electric motors 124 receive power from the batteries 114 and propel the semi-trailer hauling tractor 110. Examples of the electric motors 124 that can propel the semi-trailer hauling tractor 110 include but are not limited to a brushless DC motor (BLDC), permanent magnet synchronous motor, induction motor, switched reluctance motor (SRM), AC induction motor, hub motor, axial flux motor, and a linear motor. These electric motors 124 can be powered by various types of the batteries 114 such as Lithium-Ion (Li-ion) batteries, Nickel-Metal Hydride (NiMH) batteries, Solid-State batteries, Lithium Polymer (LiPo) batteries, Sodium-Ion batteries, graphene batteries, flow batteries, and Zinc-Air batteries.

The connecting cables facilitate two-way data and power transmission among the container 102, the semi-trailer 106, and the semi-trailer hauling tractor 110. In an embodiment, the connecting cables may be data cables and power cables. Data cables and power cables are connected between the semi-trailer hauling tractor, semi-trailer, and the container to enable two-way data and power transfer.

The power management module 116 monitors the energy status of the batteries 114 and data, and power transmission with the semi-trailer hauling tractor 110. Thus, the power management module 116 handles battery management and data communications with the semi-trailer hauling tractor 110 which is the primary hauling mechanism.

The memory 118 is connected to the power management module 116 to store data related to the energy status of the batteries 114, destination of freight, and container data. The processor 120 is in connection with the memory 118 to execute the data, software programs, and applications stored in the memory 118. The memory 118 may include computer-readable code that may be executable by one or more processors to perform predetermined operations. The memory may be a non-volatile memory or a volatile memory. Examples of nonvolatile memory may include, but are not limited to flash memory, Read Only Memory (ROM), a Programmable ROM (PROM), Erasable PROM (EPROM), and Electrically EPROM (EEPROM) memory. Examples of volatile memory may include but are not limited to Dynamic Random-Access Memory (DRAM), and Static Random-Access Memory (SRAM).

In an embodiment, the data transmission module 122 is connected to the processor 120 to transmit the data to a remote server 108. Examples of the data transmission module 122 include but are not limited to wireless communication modules, cellular modules, NFC (Near Field Communication), Zigbee, LoRa modules, RFID (Radio-Frequency Identification) modules like those supporting 4G or 5G networks, enable real-time data transmission over cellular networks. The data transmission module 122 can be used for tracking the freight, monitoring battery status, and sending updates to a remote server i.e. a central system. Further, the data transmission module 122 may be used for secure data transfer or authentication, such as when connecting components within proximity. In another embodiment, the data transmission module 122 includes but is not limited to a transmitter, a receiver, and a transceiver.

In an embodiment, the remote server 108 is configured to execute a centralized container management software based on the data received from the data transmission module 122 to predict, manage, and plan routes for the freight using a communication system such as GPS, cellular communication, and satellite communication. According to an embodiment herein, the remote server 108 is connected with one or more computing devices 104 to facilitate a user to access and monitor the centralized container management software. As used herein, the remote server 108 is any server computer capable of performing functions stored in a computer-readable storage medium of the application server. The application server may download the program code to the processor 120 for use on the present system, computing devices, client computers, or electronic devices. Alternatively, the remote server 108 can be remote so that complex computing and calculations can be performed at a location with higher performance capabilities which helps keep the present system simpler and more economical.

According to an embodiment herein, the data transmission module 122 of the container 102, the remote server 108, and the computing devices 104-1, 104-2, 104-3, and 104-N (hereinafter referred to as 104) are connected over a network 112. Network 112 may be a wired or a wireless network, and the examples may include but are not limited to the Internet, Wireless Local Area Networks (WLANs), Wi-Fi, Long Term Evolution (LTE), Worldwide Interoperability for Microwave Access (WiMAX), and General Packet Radio Service (GPRS). The one or more computing devices 104 may comprise one or more data processors and one or more memories.

In an embodiment, the data related to tracking and monitoring of the semi-trailer hauling tractor (which may act as electric vehicles or EVs), charging patterns, battery status, and battery health is displayed over the one or more computing devices 104. Examples of computing devices 104 include but are not limited to a smartphone, a laptop, a computer, a tablet, and a mobile device. Examples of the users include but are not limited to an administrator of the freight transportation system, drivers, owners of the charging depot, etc.

In an embodiment, the processor 120 is configured to manage power delivery, braking, and signaling information to the semi-trailer 106. The processor 120 may include at least one data processor for executing program components for executing user-or system-generated requests. The processor 120 may include specialized processing units such as integrated system (bus) controllers, memory management control units, floating-point units, graphics processing units, digital signal processing units, etc. The processor 120 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. The processor 120 may be implemented using a mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), cloud services, etc.

FIG. 2 illustrates a perspective view of integrating the container 102, semi-trailer 106, and the semi-trailer hauling tractor 110, in accordance with one or more example embodiments. The container 102 has integrated batteries 114 along with an electric motor-powered semi-trailer 106, and a compatible electric semi-trailer hauling tractor 110 to transport freight between geographic locations. In an embodiment, the container 102 is disengaged from the semi-trailer 106 during storage, charging, and loading. In an embodiment, the semi-trailer hauling tractor 110 includes an onboard module or a controller configured to manage a propulsion management unit to haul the freight transportation system. Examples of the propulsion management unit include but are not limited to acceleration and brakes.

FIG. 3 illustrates a perspective view of the container 102, in accordance with one or more example embodiments. The container 102 includes custom-designed partitions to house the batteries or battery packs or battery modules. The batteries 114 are placed in the form of a plurality of slidable and removable racks that fit into the floor of the container 102. In an embodiment, the batteries 114 are charged at one or more of a freight handling station, a freight delivery location, and a charging station. In an exemplary embodiment, the charging station may be a central depot or a delivery logistic warehouse where all the semi-trailer hauling tractors need to be at the warehouse to collect the goods and freight for distribution. In an embodiment, the charging station or EV charging unit automatically calculates the optimum number of battery modules to the mated to the freight containers depending on factors including distance to be traveled, payload weight, and weather conditions. The optimum number of battery modules is automatically calculated using various software systems using inputs or parameters based on battery, container weight, container-payload weight, terrain data, etc.

The batteries 114 can be fit into one container or various containers. Examples of the container is a shipping container of standard sizes including but not limited to ISO, North American, and European. Charging the batteries 114 or battery packs contained within the shipping containers can be performed at freight handling stations, freight delivery locations, or any facility equipped to charge electric vehicles. The semi-trailer hauling tractor may include a controller to manage power delivery, braking, and signaling information to the semi-trailer. The container can be disengaged from the semi-trailer hauling tractor at any time for storage, charging, or loading. The trailer system motors derive power from the batteries in the container 102. In an embodiment, the freight transportation system may include multiple containers that can be mated together via data or power cables for power distribution and propulsion management.

Thus, the battery 114 consists of slidable or removable racks that fit into the floor of existing containers. External power sources will be used to charge the battery, and onboard charge management computers will handle power management. Battery stacks can be added or removed based on the required travel range and weight limits. The ‘in-container’ battery system powers motors mounted in the trailer. The semi-trailer hauling tractor obtains primary power as needed from the container batteries to propel itself and tow the freight trailers.

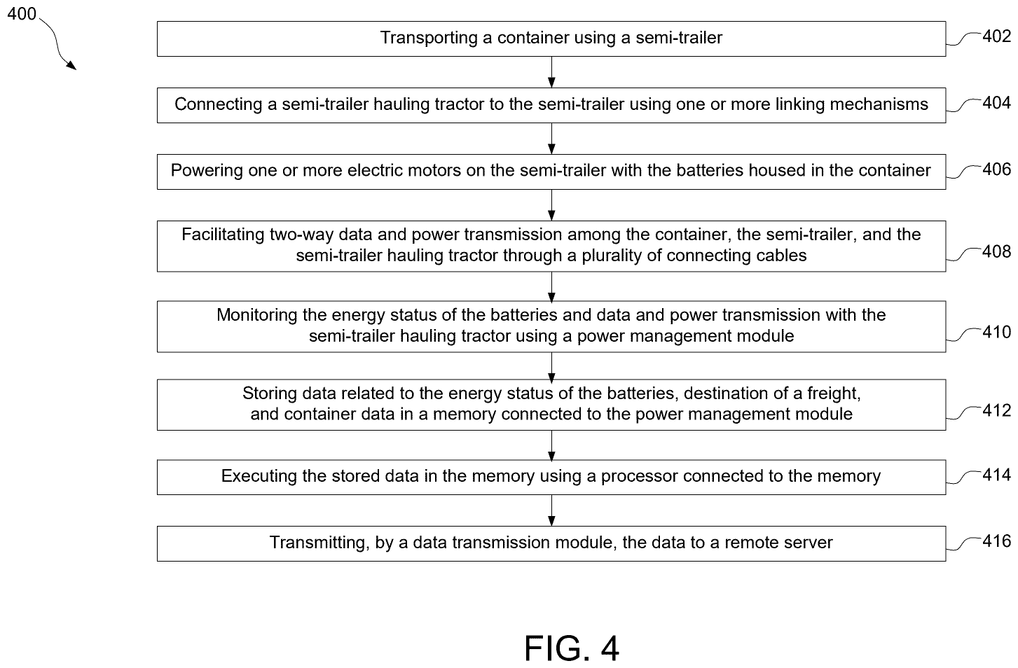

FIG. 4 is a flowchart of a method 400 for operating the freight transportation system, in accordance with one embodiment of the present disclosure. The method 400 includes a step 402 of transporting a container using a semi-trailer. In an additional method embodiment, the container includes a plurality of partitions housing a plurality of batteries. The method 400 includes a step 404 of connecting a semi-trailer hauling tractor to the semi-trailer using one or more linking mechanisms. The method 400 includes a step 406 of powering one or more electric motors on the semi-trailer with the batteries housed in the container. The method 400 includes a step 408 of facilitating two-way data and power transmission among the container, the semi-trailer, and the semi-trailer hauling tractor through a plurality of connecting cables. The method 400 includes a step 410 of monitoring the energy status of the batteries and data and power transmission with the semi-trailer hauling tractor using a power management module. The method 400 includes a step 412 of storing data related to the energy status of the batteries, destination of a freight, and container data in a memory connected to the power management module. The method 400 includes a step 414 of executing the stored data in the memory using a processor connected to the memory. The method 400 includes a step 416 of transmitting, by a data transmission module, the data to a remote server. In an aspect, the remote server is configured to execute a centralized container management software based on the data received from the data transmission module to predict, manage, and plan routes for the freight using a communication system. In an aspect, the batteries are charged at either a freight handling station, a freight delivery location, or an electric vehicle charging station. In an aspect, the container is disengaged from the semi-trailer during storage, charging, and loading. In an aspect, the semi-trailer hauling tractor includes an onboard module configured to manage a propulsion management unit to haul the freight transportation system. In an aspect, the batteries are placed in the form of a plurality of slidable and removable racks that fit into the floor of the container.

Accordingly, one advantage of the present invention is that the container is used to provide electric power to the trailer system to which it is mated. In an aspect, the trailer system includes the semi-trailer, and the semi-trailer hauling tractor.

Accordingly, one advantage of the present invention is that the batteries or battery modules of the container can be swapped out to optimize the power required to transport the trailer system to a predetermined destination.

Thus, the present invention utilizes both existing and new freight containers retrofitted with removable battery modules as a practical electrical power source for trailer systems utilizing electric motors as the primary propulsion method.

Unless otherwise defined, all terms (including technical and scientific terms) used in this disclosure have the same meaning as commonly understood by one of ordinary skill in the art to which this disclosure belongs. In this specification, “mobile phone” and “smartphone” are interchangeable as are “tablet” and “smart tablet.” It is to be understood that the phrases or terms employed by the present invention are for description and not for limitation. As will be appreciated by one of the skills in the art, the present disclosure may be embodied as a device, system, method, or computer program product. Further, the present invention may take the form of a computer program product on a computer-readable storage medium having computer-usable program code embodied in the medium. The present systems and methods have been described above with reference to specific examples. However, other embodiments and examples than the above description is equally possible within the scope of the present invention. The scope of the disclosure may only be limited by the appended patent claims. Even though modifications and changes may be suggested by the persons skilled in the art, it is the intention of the inventors and applicants to embody within the patent warranted heron all the changes and modifications as reasonably and properly come within the scope of the contribution the inventors and applicants to the art. The scope of the embodiments of the present invention is ascertained with the claims to be submitted at the time of filing the complete specification. Method steps can be performed in any order unless required otherwise by the context. In the specification and claims, a feature mentioned in the singular (e.g., using “a” or “an”) will be deemed to have an “at least one” or plural construction except where the context indicates such construction is unworkable. A person of skill in the art will also recognize that the embodiments discussed herein are reconfigurable and within the intended scope. For example, the dependent claims from one independent claim or dependent claim can be similarly made to depend on a different independent claim and/or dependent claim, unless prohibited by the context. In addition, as would be appreciated by a person of skill in the art, certain features or elements of a claim can be mixed and matched with other features or elements, even if not presented together at the time of filing. Similarly, as would be appreciated by a person of skill in the art, data, outputs, and readings from different described sensors, user inputs, and other sources can be used together, even if not presented together at the time of filing. The term “and/or” in a list means all list items present, some list items present, or one of the list items present unless such construction is limited by the context. Positional and directional terms described in this specification may be understood to be different than shown or described and should not limit the variations of embodiments possible from the claimed features that a person of ordinary skill in the art would understand from the specification, figures, and claims.

1. A freight transportation system, comprising:
a container;
a semi-trailer configured to transport the container, wherein the container comprises a plurality of partitions to house a plurality of batteries to power one or more electric motors placed on the semi-trailer;
a semi-trailer hauling tractor mated with the semi-trailer using one or more linking mechanisms, wherein the electric motors receive power from the batteries and propel the semi-trailer hauling tractor;
a plurality of connecting cables facilitating two-way data and power transmission among the container, the semi-trailer, and the semi-trailer hauling tractor;
a power management module to monitor an energy status of the batteries and data, and power transmission with the semi-trailer hauling tractor;
a memory connected with the power management module to store data related to energy status of the batteries, a destination of a freight, and container data; and
a processor in connection with the memory to execute the data stored in the memory.

2. The freight transportation system of claim 1, wherein the container comprises a data transmission module connected with the processor to transmit the data to a remote server.

3. The freight transportation system of claim 1, wherein the remote server is configured to execute a centralized container management software based on the data received from the data transmission module to predict, manage, and plan routes for the freight using a communication system.

4. The freight transportation system of claim 1, wherein the batteries are charged at one or more of a freight handling station, a freight delivery location, and an electric vehicle charging station.

5. The freight transportation system of claim 1, wherein the processor is configured to manage power delivery, braking, and signaling information to the semi-trailer.

6. The freight transportation system of claim 1, wherein the container is disengaged from the semi-trailer during storage, charging, and loading.

7. The freight transportation system of claim 1, wherein the semi-trailer hauling tractor comprises an onboard module configured to manage a propulsion management unit to haul the freight transportation system.

8. The freight transportation system of claim 1, wherein the batteries are placed in the form of a plurality of slidable and removable racks that fit into a floor of the container.

9. A method for operating a freight transportation system, comprising the steps of:
transporting a container using a semi-trailer, wherein the container includes a plurality of partitions housing a plurality of batteries;
connecting a semi-trailer hauling tractor to the semi-trailer using one or more linking mechanisms;
powering one or more electric motors on the semi-trailer with the batteries housed in the container;
facilitating two-way data and power transmission among the container, the semi-trailer, and the semi-trailer hauling tractor through a plurality of connecting cables;
monitoring the energy status of the batteries and data and power transmission with the semi-trailer hauling tractor using a power management module;
storing data related to the energy status of the batteries, destination of a freight, and container data in a memory connected to the power management module; and
executing the stored data in the memory using a processor connected to the memory.

10. The method of claim 9, further comprises a step of transmitting, by a data transmission module, the data to a remote server.

11. The method of claim 9, wherein the remote server is configured to execute a centralized container management software based on the data received from the data transmission module to predict, manage, and plan routes for the freight using a communication system.

12. The method of claim 9, wherein the batteries are charged at one or more of a freight handling station, a freight delivery location, and an electric vehicle charging station.

13. The method of claim 9, wherein the container is disengaged from the semi-trailer during storage, charging, and loading.

14. The method of claim 9, wherein the semi-trailer hauling tractor comprises an onboard module configured to manage a propulsion management unit to haul the freight transportation system.

15. The method of claim 9, wherein the batteries are placed in the form of a plurality of slidable and removable racks that fit into a floor of the container.
